(19) United States
(12) Patent Application Publication
(10) Pub. No.: US 2009/0074934 A1
(43) Pub. Date: Mar. 19, 2009

(54) Processed rice food having active oxygen-scavenging potential, food having hightened active oxygen-scavenging potential and method of producing the same

(76) Inventors: Yoshinobu Akiyama, Akita (JP); Naganori Ohisa, Akita (JP); Makio Takahasi, Akita (JP)

Correspondence Address: WENDEROTH, LIND & PONACK, L.L.P., 2033 K STREET N. W., SUITE 800, WASHINGTON, DC, 20006-1021, US

(21) Appl. No.: 12/219,544

(22) Filed: Jul. 23, 2008

Related U.S. Application Data
(63) Continuation of application No. 11/299,621, filed on Dec. 13, 2005, now abandoned.

(51) Int. Cl. A23L 1/29; A23L 1/48; A23L 2/38; A23F 3/34; A23L 1/10

(52) U.S. Cl. 426/543; 426/519

(57) ABSTRACT

The object of the invention was achieved by a processed rice food having an active oxygen-scavenging potential that is produced by preparing a liquid mixture of brown rice powder, soy bean, soymilk or tea powder, and water and heating the mixture at 60 to 90° C. for 30 to 50 minutes.

### BACKGROUND OF THE INVENTION

1. Field of the Invention

The invention relates to a processed rice food having an active oxygen-scavenging potential prepared by blending soy bean powder, tea (e.g., green tea) powder, or the like to rice powder and cooking the mixture or adding a phosphoric acid group-containing substance thereto, food having a heightened active oxygen-scavenging potential and a method of producing the same.

2. Description of the Related Art

Active oxygen is attracting attention as a causative substance of cancer and life-style diseases. It is known that there are some ingredients contained in grains and beans that scavenge the active oxygen (Luminescence, 16, 237-241, 2001). The inventors have also found that it is possible to increase the active oxygen-scavenging potential of rice drastically by blending rice with soy bean or tea, and studied the phenomenon in detail (Proceedings of the 3rd international soybean processing and utilization conference, 183-184, 2000). The ingredients involved in the synergic effect generation have been thiamin, inositol-6-phosphoric acid contained in rice and grains, catechin in tea, and isoflavone in soy bean.

Also known is an active oxygen-inhibiting composition that is prepared by steaming a primary composition containing adlay (Coix ma-yuen) in an amount of 60 to 80 wt % with respect to the total weight and soy bean, wheat germ and rice bran and/or brown rice germ respectively in amounts of 7.5 to 27.5 wt % at 50 to 150° C. or roasting and then steaming it at 50° C. to 150° C., fermenting it after addition of at least one of mold and yeast, and adding sesame powder and green tea powder respectively in amounts of 20 to 30 wt % and 10 to 20 wt % after fermentation.

Active oxygen is attracting attention as a causative substance of cancer and life-style diseases and believed to induce the diseases when active oxygen produced excessively in the body. A group of substances that remove the toxicity of active oxygen are called active oxygen-scavenging substances and are known to be present in grains, vegetables, fruits, and others. Polyphenols, flavonoids, and the like are known as the active oxygen-scavenging substances.

### [Patent Document 1] Japanese Patent 2610325

### SUMMARY OF THE INVENTION

There is had a problem that the active oxygen-scavenging potential of food declined drastically when the food is processed by the conventional technique.

After studies on the unstabilizing factors, the inventors have found that the heating step, for example in production of processed foods such as pudding with a combination of soy bean and rice, destroys the active oxygen-scavenging potential of the food and thus is one of the unstabilizing factors.

The problem was observed not only in production of the pudding but also in production of processed foods in general.

In addition, addition of an active oxygen-scavenging substance, which is mostly bitter and sour, in a greater amount caused a problem of deterioration of the taste of foods.

The invention solves the traditional problems above, by using a material having an active oxygen-scavenging potential and cooking it at a relatively lower temperature or adding a phosphoric acid group-containing substance.

Thus, the invention relates to a processed rice food having an active oxygen-scavenging potential that is produced by preparing a liquid mixture of soy bean powder, soymilk or tea powder, and brown rice powder and water, and heating the mixture at 60 to 90° C. for 30 to 50 minutes, wherein the ratio of the soy bean powder, soymilk or tea powder to the brown rice powder is 10 to 150% (wt %).

In another aspect, the invention provides a food having an heightened active oxygen-scavenging potential that is prepared by adding a phosphoric acid group-containing substance to a polyphenol or flavonoid-containing grain or other food, wherein as the phosphoric acid group-containing substance, a thiamin derivative or an inositol phosphoric acid derivative are used, and as the grain or other food, brown rice powder, soy bean powder, or soymilk or tea powder are used.

Yet in another aspect of the invention, the amount of the phosphoric acid group-containing substance added is 1 to 15 mg with respect to 1 g of the food.

The invention also provides a method of producing a processed rice food having a heightened active oxygen-scavenging potential, comprising the steps of preparing a liquid mixture by adding and agitating a brown rice powder and one or more of soy bean powder, soymilk and tea powders in a container and heating the liquid mixture at 60 to 90° C. for 30 to 50 minutes, wherein the amount of the brown rice powder used is 10 to 60% (wt %) with respect to the total amount of the components.

It is found in the invention that a combination of soy bean and rice or rice and green tea is drastically effective in increasing the active oxygen-scavenging potential of rice, soy bean, or green tea.

For example, an equivalent combination of rice and soy bean is found to have a synergic effect, i.e., an active oxygen-scavenging potential four or more times greater than that inherent to the brown rice or the soy bean.

In another equivalent combination of rice and green tea, a synergic effect of approximately three times greater than that when rice or green tea was used alone was observed.

The invention is aimed at prevention of deterioration and stabilization of the active oxygen-scavenging potential during cooking a food with utilizing such a synergic effect.

The invention is also made based on the finding that the active oxygen-scavenging potential was increased approximately two to five times when a phosphoric acid group-containing substance is co-present with the active oxygen-scavenging substance. That is, it was possible to obtain a food having an active oxygen-scavenging potential synergistically strengthened by addition of an active oxygen-scavenging substance such as thiamin or an inositol phosphoric acid derivative.

The active oxygen, which damages human body cell, is said to be a cause of aging, and suppression of the active oxygen is regarded to be effective in accelerating fatigue recovery and preventing deterioration of muscular strength, stiffness and pain of the body, and other bodily functions.

In addition to the aging phenomenon, it is also said to be the causes of various diseases such as rheumatoid arthritis, arteriosclerosis, stroke, myocardial infarction, and diabetes.

The active oxygen, which decomposes biologically foreign materials in the body, is a substance needed for body protection, but excessive production thereof may damage body cells.

Thus, the body produces superoxide dismutase (hereinafter, referred to as SOD) in the cell for protection of the body by decomposing the active oxygen produced in an excessive amount and thus, protect the health of the body by adjusting the balance of SOD.

However, the activity of SOD declines rapidly in mature or old age, consequently permitting progress of the various diseases above.

The invention was completed, aiming at providing a food having a higher active oxygen-scavenging potential to compensate the deterioration in production of SOD in mature or old age.

Because the heating temperature and period are noted carefully when a food containing rice and soy bean or tea are produced, the invention provides a food having a high active oxygen-scavenging potential while preserving the favorable flavor and others of the food sufficiently.

The invention also allows easier and simpler production of foods. Thus, it provides foods that are effective for preventing cancer and other life-style diseases.

The invention allows production of a food having an active oxygen-scavenging potential heightened approximately 2 to 5 times. Accordingly, such a food is expected to be effective for prevention of cancer and life-style diseases and sustainment of health. In addition, the food, which has an enhanced active oxygen-scavenging potential and retains its storage life, taste, and others as a food, may be treated and taken in a similar manner to conventional products.

### DESCRIPTION OF THE PREFERRED EMBODIMENTS

The invention is aimed at providing a food, such as food containing brown rice and soy bean powder or soymilk, food containing brown rice, soy bean powder and green tea, or food containing brown rice and green tea, more favorable than conventional products with preserving the active oxygen-scavenging potential of the food, by taking into consideration the cooking temperature, heating time, and others during production of food.

The active oxygen-scavenging potential of the food is preserved even when the other materials (e.g., milk, sugar, and seasonings) are added, and thus, the applications of the food as a food material is not particularly limited. However, decrease in the amounts of brown rice, soy bean powder, soymilk, green tea, and the like leads to decrease of the active oxygen-scavenging potential, and thus, they should be contained in some amounts (e.g., 10% or more with respect to the total volume). The blending ratio of rice to soy bean, rice to green tea, or the like is preferably 20% to 50% (wt %) more than the equivalent amount, from the point of synergic effect.

The food produced by the invention is a food prepared by blending a natural product (agricultural, forest or marine product) containing an active oxygen-scavenging substance and a natural product containing a phosphoric acid group-containing substance. The shape, kind, and consumption method of the food are not particularly limited. The active oxygen-scavenging substance contains at least one substance selected from polyphenols and flavonoids. The phosphoric acid group-containing substance contains at least one substance selected from thiamin and inositol phosphoric acid derivatives.

### Example 1

Milk (400 ml), soy bean powder (100 g), distilled water (300 ml), soymilk (400 ml), brown rice powder (50 g), and trehalose (50 g) were added in this order into a 2-liter stainless steel container allowing heating and mixing, and the mixture was heated gradually at 60° C. Then, agar (8 g) and vanilla (1 g) after sufficient mixing were mixed thereto sufficiently, and the mixture was further heated to 90° C. and kept at the same temperature for 30 minutes. The mixture was divided into 100 ml aliquots in polyethylene cups, while it was kept at 80° C. Each of the cups was covered and heat-sealed with a PP/EVA/KNY sheet, and a soy bean and rice pudding was prepared.

### Example 2

Soy bean (product name: Ryuho) containing isoflavone which is an active oxygen-scavenging substance, in an amount of 280 mg with respect to 100 g, was immersed in water overnight, and the mixture was ground with a quintuple amount of water was added thereto, to give a soy bean slurry. The slurry was heated at 102° C. for 5 minutes, and the bean-curd generated was removed, to give a soymilk. The active oxygen-scavenging potential of the soymilk was measured to be 40 as a value relative to gallic acid (relative value with respect to 100 of the light intensity of 2,200 μl of 2-mM gallic acid). Brown rice containing a thiamin phosphoric acid derivative in an amount of 0.1 mg with respect to 100 g (product name: Akitakomachi) was ground to fine powder, and the active oxygen-scavenging potential was measured to be 60. The brown rice powder (10 g) was added to and mixed with the above soymilk (100 g), and soybean curd (tofu) was prepared according to a known method. The soybean curd, which was almost not different in taste from the soybean curd prepared only from soymilk, had an active oxygen-scavenging potential increased approximately 3.5 times. The active oxygen-scavenging potentials of respective raw materials and products are summarized in Table 1.

TABLE 1
Active oxygen-scavenging potential of
soybean curd containing brown rice

| | Active oxygen- |
|---|---|
| Raw material/product | scavenging potential |
| Soymilk | 40 |
| Brown rice powder | 60 |
| Soybean curd with brown rice powder | 175 |
| Soybean curd without brown rice powder | 35 |

The active oxygen-scavenging potential was measured by XYZ type active oxygen-scavenging emission analysis. Specifically, a solution of 196 mM hydrogen peroxide and a solution of potassium bicarbonate-saturated 360-mM acetaldehyde were added to the sample, and the active oxygen-scavenging emission generated at the time was measured by using a low-level emission analyzer (ARGAS-50, manufactured by Hamamatsu Photonics). The active oxygen-scavenging potential is expressed as a relative value with respect to 100 of the light intensity of 200 μl of 2 mM solution of a typical scavenger gallic acid.

### Example 3

Buckwheat (100 g) containing inositol-6-phosphoric acid which is a phosphoric acid derivative, in an amount of 6.5 mg with respect to 1 g of the buckwheat, was added to and mixed with 1,000 ml of a green tea extract, and the mixture was heated and sterilized at 100° C. for 3 minutes. The active oxygen-scavenging potential thereof measured is shown in Table 2. A green tea drink having an active oxygen-scavenging potential higher than normal green tea extract was obtained.

TABLE 2
Active oxygen-scavenging potential of green tea drink

| | Active oxygen- |
|---|---|
| Raw material/product | scavenging potential |
| Green tea extract solution | 420 |
| Buckwheat | 70 |
| Green tea drink with buckwheat | 960 |

### Example 4

Milk (400 ml), distilled water (400 ml), brown rice powder (50 g), and trehalose (50 g) were added in this order into a 2-liter stainless steel container allowing joule heating and mixing, and the mixture was heated gradually at 60° C. In addition, agar (8 g) and vanilla (1 g) were added thereto, and the mixture was agitated for 10 minutes. The mixture was further heated to 85° C. and kept at the same temperature for 30 minutes.

### Example 5

Milk (400 ml), soymilk (400 ml), brown rice powder (50 g), and trehalose 50 g were added in this order into a 2-liter stainless steel container allowing joule heating and mixing, and the mixture was heated gradually at 60° C. In addition, agar (8 g) and vanilla (1 g) were added thereto, and the mixture was agitated for 10 minutes. The mixture was further heated to 80° C. and kept at the same temperature for 40 minutes.

### Experimental Example

Milk (400 ml), soymilk (400 ml), brown rice powder (100 g), and sucrose (50 g) were added in this order into a 2-liter stainless steel container allowing heating and mixing, and the mixture was heated gradually to 60° C. and agitated at the same temperature for 10 minutes. The mixture was divided into 100 ml aliquots in beakers, and the aliquots were heated respectively at 70° C., 80° C., 90° C., 100° C. and 110° C. for 30 minutes. Heating at 100° C. was performed by using boiling water, while heating at 110° C. by using an autoclave. The heat-treated mixtures were cooled to room temperature, and then, the active oxygen-scavenging potential thereof was determined.

The active oxygen-scavenging potential was measured by XYZ type active oxygen-scavenging emission analysis. Specifically, the active oxygen species used (X) was 196-mM hydrogen peroxide, and the mediator (Z) was potassium bicarbonate-saturated 360 mM acetaldehyde. A low-level emission image was obtained by using ARGAS50 system (manufactured by Hamamatsu Photonics) and the active oxygen-scavenging activity was calculated from the low-level light intensity.

The results are summarized in Table 3.90% or more of the active oxygen-scavenging potential was preserved at a temperature of up to 90° C., but the active oxygen-scavenging potential declined significantly at a temperature of 100° C. or 110° C.

TABLE 3
Experimental results

| | Relative active oxygen- |
|---|---|
| Experiment group | scavenging potential |
| 60° C. | 100° C. |
| 70° C. | 99 |
| 80° C. | 95 |
| 90° C. | 92 |
| 100° C. | 79 |
| 110° C. | 53 |

Although the preferred examples of the invention have been described, however, the invention is not limited to those examples, but can be modified in various examples within the technical scope grasped from the appended claims.

What is claimed is:

1. A processed rice food having an active oxygen-scavenging potential, prepared in the steps comprising preparing a liquid mixture of soy bean, soymilk or tea powder, brown rice powder and water, and heating the mixture at 60 to 90° C. for 30 to 50 minute.

2. The processed rice food having an active oxygen-scavenging potential according to claim 1,
wherein the ratio of the soy bean powder, soymilk or tea powder to brown rice powder is 10 to 150% (wt %).

3. A food having a heightened active oxygen-scavenging potential, prepared by adding a phosphoric acid group-containing substance to polyphenol or flavonoid-containing grain or other food.

4. The food having a heightened active oxygen-scavenging potential according to claim 3,
wherein the phosphoric acid group-containing substance is a thiamin derivative or an inositol phosphoric acid derivative.

5. The food having a heightened active oxygen-scavenging potential according to claim 3,
wherein the grain or other food is brown rice powder, soy bean powder, soymilk, or tea powder.

6. The food having a heightened active oxygen-scavenging potential according to claim 3,
wherein the amount of the phosphoric acid group-containing substance added is 1 to 15 mg with respect to 1 g of the food.

7. A method of producing a processed rice food having an active oxygen-scavenging potential, comprising the steps of preparing a liquid mixture by adding and blending brown rice powder and one or more of soy bean powder, soymilk, and tea powder into a container and heating the liquid mixture at 60 to 90° C. for 30 to 50 minutes.

8. The method of producing a processed rice food having a heightened active oxygen-scavenging potential according to claim 7,
wherein the amount of the brown rice powder used is 10 to 60% (wt %) with respect to the total amount of the components.
